(19) United States
(12) Patent Application Publication
(10) Pub. No.: US 2012/0115991 A1
(43) Pub. Date: May 10, 2012

(54) COMPOSITION FOR MANUFACTURING A SCRATCH-PROOF COATING WITH IMPROVED RESISTANCE TO BASES

(75) Inventors: Norbert Hugenberg, Aalen (DE); Bin Peng, Aalen (DE); David Diggins, Flagstaff Hill (AU); Anja Petereit, Abtsgmund (DE); Joerg Puetz, Aalen (DE)

(73) Assignees: Carl Zeiss Vision Australia Holdings Ltd., Lonsdale (AU); Carl Zeiss Vision GmbH, Aalen (DE)

(21) Appl. No.: 13/102,408

(22) Filed: May 6, 2011

Related U.S. Application Data
(60) Provisional application No. 61/331,877, filed on May 6, 2010.

(30) Foreign Application Priority Data
May 6, 2010 (DE) DE102010028661.2

(51) Int. Cl. C09D 183/00; B05D 7/24; B05D 3/00; C08K 13/02

(52) U.S. Cl. 523/435; 427/387

(57) ABSTRACT

A coating forming composition that includes:
(a) a silane derivative of Formula (I)

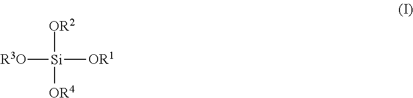

wherein
R¹, R², R³ and R⁴ that can be the same or different are selected from alkyl, acyl, alkylene acyl, cycloalkyl, aryl or alkylene aryl that can where necessary be substituted,
and/or a hydrolysis product and/or condensation product of the silane derivative of Formula (I),
(b) a silane derivative of Formula (II)

R⁶R⁷₃₋ₙSi(OR⁵)ₙ (II)
wherein
   R⁵ is an unsubstituted or substituted alkyl, acyl, alkylene acyl, cycloalkyl, aryl or alkylene aryl group,
   R⁶ is an organic residue that contains an epoxide group,
   R⁷ is an unsubstituted or substituted alkyl, cycloalkyl, aryl or alkylene aryl group,
   n is 2 or 3,
and/or a hydrolysis product and/or condensation product of the silane derivative of Formula (II),
(c) a colloidal inorganic oxide, fluoride or oxyfluoride,
(d) a cycloaliphatic or aromatic epoxide, and
(e) a solvent.

### CROSS REFERENCE TO RELATED APPLICATION

This application claims the benefit of U.S. Provisional Application Ser. No. 61/331,877, entitled Composition for the Preparation of an Abrasion Resistant Coating with Improved Caustic Resistance, filed on May 6, 2010, the entire disclosure of which is hereby incorporated by reference. This application also claims priority to German application No. DE 10 2010 028 661.2, filed on May 6, 2010, the entire disclosure of which is hereby incorporated by reference.

### BACKGROUND OF THE INVENTION

Transparent polymers are increasingly being used in the area of optics and optoelectronics, as these materials offer advantages in terms of weight reduction and resistance to breaks. Components with more complex three-dimensional geometry, such as lenses and lens elements, can also be manufactured in relatively large quantities in the area of precision optics.

Example plastic materials currently being used in optics include polymethyl-methacrylate, polycarbonate, diethylene glycol bis allyl carbonate (trade name CR39®) and special, highly refractive polymers based on polythiourethane.

One of the disadvantages of these plastic materials is their relatively low surface hardness and scratch-resistance.

A well-known approach for improving scratch-resistance involves applying a surface coating as part of a sol-gel process. Here, it is possible to use tetra-alkoxysilanes, which hydrolyse under suitable conditions, and which result in a three-dimensionally networked silicate structure once the silanol groups created by the hydrolysis have undergone condensation.

In addition to having the highest possible degree of scratch resistance, the surface coating should also meet a series of other requirements. These include having the lowest possible tendency to crack under thermal exposure, adhering as strongly as possible to the substrate surface, and being as resistant as possible to acids and/or bases. Furthermore, the coating's refractive index should be capable of being adapted to that of the substrate as much as possible.

When fulfilling these criteria, however, it must be taken into account that these properties very often counteract one another, so one is usually only improved at the price of another.

To increase the flexibility of the silicate network, and thus reduce its tendency to crack under thermal exposure, the tetra-alkoxysilanes are often used in combination with organo-alkoxysilanes (i.e. silanes which, apart from alkoxy groups, also display one or more organic residues bonded directly to the Si atom). Although the resulting organic-inorganic network structure has greater flexibility and base stability, this is achieved at the price of a lower degree of hardness compared to the purely inorganic silicate network.

U.S. Pat. No. 3,986,997 describes an aqueous composition containing colloidal SiO₂, as well as an organo-trialkoxysilane, such as methyltrimethoxysilane, and/or products resulting from the hydrolysis and/or condensation this organo-trialkoxysilane.

It is also known to use tetra-alkoxysilane or colloidal SiO₂, as well as an organo-alkoxysilane whose organic residue contains an epoxy group, to be used in combination with a dicarboxylic acid or a dicarboxylic acid anhydride.

US 2001/0049023 A1 discloses a composition for coating a substrate based on a mixed aqueous organic solvent containing (i) an organo-alkoxysilane with epoxide functions or the products resulting from the hydrolysis and/or condensation of this organo-alkoxysilane, (ii) a tetra-alkoxysilane or the products resulting from the hydrolysis and/or condensation of this tetra-alkoxysilane and (iii) a dicarboxylic acid or dicarboxylic acid anhydride.

The use of tetra-alkoxysilane/colloidal SiO₂, as well as an organo-alkoxysilane whose organic residue contains an epoxy group, combined with a dicarboxylic acid or dicarboxylic acid anhydride is also discussed in U.S. Pat. No. 4,355,135 and U.S. Pat. No. 5,322,888.

WO 2008/087741 discloses a coating composition containing (A) a poly(methyl) glycidyl ether compound with aliphatic residue R1, (B) a silsesquioxane, (C) an alkoxy compound, (D) an organo-alkoxy compound whereby the organic residue bonded to the Si atom has a cationically polymerisable group such as an epoxy group, and (E) a photopolymerization catalyst. With regards to suitable multi-functional epoxy compounds as component (A), WO 2008/087741 states that cyclic epoxy compounds, i.e. cycloaliphatic and aromatic epoxy compounds, are not suitable for manufacturing sufficiently hard coatings.

Taking into account the above information, it is an object of an embodiment of the present invention to provide a composition enabling production of a coating which achieves a better compromise in terms of high scratch resistance with low tendency to crack under thermal exposure, good adhesion to the substrate surface, and high resistance to acids and/or bases.

### BRIEF SUMMARY OF THE INVENTION

A composition suitable to manufacture a coating typically includes:
(a) a silane derivative with Formula (I)

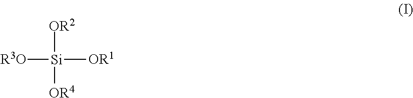

where
R¹, R², R³ and R⁴, that can be the same or different, are selected from alkyl, acyl, alkylene acyl, cycloalkyl, aryl or alkylene aryl, which can be substituted if necessary,
and/or a hydrolysis product and/or condensation product of the silane derivative of Formula (I),
(b) a silane derivative with Formula (II)

R⁶R⁷₃₋ₙSi(OR⁵)ₙ (II)

where
R⁵ is an unsubstituted or substituted alkyl, acyl, alkylene acyl, cycloalkyl, aryl or alkylene aryl group,
R⁶ is an organic residue containing an epoxy group,
R⁷ is an unsubstituted or substituted alkyl, cycloalkyl, aryl or alkylene aryl group,
n is 2 or 3,
and/or a hydrolysis product and/or condensation product of the silane derivative of Formula (II),
(c) a colloidal inorganic oxide, fluoride or oxyfluoride,
(d) a cycloaliphatic or aromatic epoxy compound with at least two epoxy groups,
(e) a solvent containing an alcohol, ether and/or ester.

In accordance with a further aspect of this invention, a method for coating a substrate is provided that includes:

providing the composition described above;

applying the composition to the substrate; and

treating the substrate at a temperature in the range of 75° C. to 150° C. for curing of the coating.

In accordance with a further aspect of this invention, an article is provided that includes:
a substrate; and
a coating on the substrate surface, whereby the coating is obtainable or is obtained through the above-mentioned method.

In accordance with a further aspect, this invention concerns the use of the above mentioned composition to coat a substrate.

These and other features, advantages, and objects of the present invention will be further understood and appreciated by those skilled in the art by reference to the following specification, claims, and appended drawings.

### DETAILED DESCRIPTION

It is to be understood that the invention may assume various alternative embodiments, except where expressly specified to the contrary. It is also to be understood that the specific compositions and processes described in the following specification are simply exemplary embodiments of the inventive concepts defined in the appended claims. Hence, specific embodiments disclosed herein are not to be considered as limiting, unless the claims expressly state otherwise.

As described in further detail below, using a composition containing components (a) to (e) enables production of a coating having by a high degree of scratch resistance, a high resistance to bases, good adhesive strength, and a low tendency for cracking.

As stated above, the composition according to this invention contains a silane derivative with Formula (I) and/or a hydrolysis product and/or condensation product of said silane derivative as component (a).

The term “a hydrolysis product and/or condensation product of the silane derivative of Formula (I)” indicates that, as part of an aspect of this invention, it is also possible for the silane derivative (I) to have been at least partly hydrolyzed by forming silanol groups, and for the condensation reaction of these silanol groups to have already established a certain degree of cross-linking.

If R¹, R², R³ and/or R⁴ is/are an alkyl group, this will preferably involve a C₁₋₈ alkyl group, or more preferably a C₁₋₄ alkyl group, which can still be substituted if necessary. For example, methyl, ethyl, n-propyl, isopropyl, n-butyl, isobutyl, tert-butyl, hexyl or octyl can be used here.

If R¹, R², R³ and/or R⁴ is/are an acyl group, this will preferably involve acetyl, propionyl or butyryl.

If R¹, R², R³ and/or R⁴ is/are an alkylene acyl group, this will preferably involve a C₁-C₆ alkylene acyl group (e.g. —CH₂-acyl; —CH₂—CH₂-acyl; etc.), whereby the acyl unit is preferably acetyl, propionyl or butyryl.

An alkylene group is understood as being a bivalent alkyl group (e.g. —CH₂—; —CH₂—CH₂—; etc.).

If R¹, R², R³ and/or R⁴ is/are a cycloalkyl group, this will preferably involve a cyclohexyl residue, which can be substituted if necessary.

If R¹, R², R³ and/or R⁴ is/are an aryl group, this will preferably involve phenyl residue which can be substituted if necessary.

If R¹, R², R³ and/or R⁴ is/are an alkylene aryl group, this will preferably involve a C₁₋₆ alkylene aryl residue (e.g. —CH₂-aryl; —CH₂—CH₂-aryl; etc.), whereby the aryl unit is preferably phenyl, which can be substituted if necessary.

Preferred silane derivatives with Formula (I) include tetramethoxysilane, tetraethoxysilane, tetrapropoxysilane, tetraisopropoxysilane, tetrabutoxysilane, tetraisobutoxysilane, tetrakis(methoxyethoxy)silane, tetrakis(methoxypropoxy)silane, tetrakis(ethoxyethoxy)silane, tetrakis(methoxyethoxyethoxy)silane, trimethoxyethoxysilane, dimethoxydiethoxysilane and relevant derivatives.

These silane derivatives with Formula (I) are generally known to the skilled person, are commercially available and/or can be made using standard processes familiar to the skilled person.

The silane derivatives with Formula (I) and/or the products resulting from the hydrolysis and/or condensation of said silane derivatives are present in the composition in an amount of 1% by weight to 35% by weight, preferably 5% by weight to 20% by weight.

As stated above, the composition according to this invention contains a silane derivative with Formula (II) and/or a product resulting from the hydrolysis and/or condensation of said derivative as component (b).

The term “the hydrolysis product and/or condensation product of the silane derivative of Formula (II)” once again indicates that, as part of this invention, it is also possible for the silane derivative (II) to have been at least partly hydrolyzed by forming silanol groups, and for the condensation reaction of these silanol groups to have already established a certain degree of cross-linking.

See the above information for residues R¹, R², R³ and R⁴ with regards to the preferred alkyl, acyl, alkylene acyl, cycloalkyl, aryl or alkylene aryl groups of residue R⁵.

Preferably, the organic residue R⁶, containing an epoxy group, has 2 to 14 C atoms.

The epoxy group in residue R⁶ preferably exists in the form of a glycidoxy group, which is preferably bonded to the silicon atom by a C₁₋₁₀-alkylene group, preferably a C₁₋₄-alkylene group, e.g. ethylene, propylene or butylene, an arylene group, e.g. phenylene, or an alkyleneether group.

Preferably, the residue R⁶ has the following Formula (III):

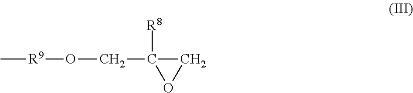

where

R⁸ is hydrogen or C₁₋₄-alkyl, preferably hydrogen, and

R⁹ is an unsubstituted or substituted C₁₋₁₀-alkylene group, preferably an unsubstituted or substituted C₁₋₄-alkylene group.

As mentioned above, an alkylene group is understood as being a bivalent alkyl group (i.e. —CH₂—; —CH₂—CH₂—; etc.).

See the above information for residues R¹, R², R³ and R⁴ with regards to the preferred alkyl, cycloalkyl, aryl or alkylene aryl groups of residue R⁷.

Preferred silane derivatives with Formula (II) include 3-glycidoxymethyltrimethoxysilane, 3-glycidoxypropyltrihydroxysilane, 3-glycidoxypropyldimethylhydroxysilane, 3-glycidoxypropyldimethylethoxysilane, 3-glycidoxypropylmethyldiethoxysilane, 3-glycidoxypropyltrimethoxysilane, 3-glycidoxypropyltriethoxysilane, 3-glycidoxypropyldimethoxymethylsilane, 3-glycidoxypropyldiethoxymethylsilane, 2-(3,4-epoxycyclohexyl)ethyltrimethoxysilane, and relevant derivatives.

These silane derivatives of Formula (II) are generally known to the skilled person and are commercially available and/or can be manufactured through standard methods known to the skilled person.

Preferably the silane derivative of Formula (II) and/or the hydrolysis products and/or condensation products of the silane derivative (II) is/are present in the composition in an amount of 1% weight to 35% weight, and preferably of 5% weight to 20% weight.

The weight ratio of the silane derivative (I) or its hydrolysis products and/or condensation products to the silane derivative (II) can in principle be varied over a wide range.

Preferably the weight ratio of the silane derivative (I) and/or its hydrolysis products and/or condensation products to the silane derivative (II) and/or its hydrolysis products and/or condensation products is in the range of 95/5 to 5/95 more, preferably in the range of 70/30 to 30/70, and even more preferably in the range of 60/40 to 40/60.

As already mentioned above, the composition in accordance with the invention as component (c) contains a colloidal inorganic oxide, fluoride or oxyfluoride or a mixture of these.

The colloidal inorganic oxide, fluoride or oxyfluoride contributes to the increase in scratch resistance through incorporation into the existing network. Furthermore, by selecting suitable oxides, fluorides or oxyfluorides, the refractive index of the coating can be adjusted to the refractive index of the substrate.

In a preferred embodiment, the inorganic oxide is selected from of SiO₂, TiO₂, ZrO₂, SnO₂, Sb₂O₃, Al₂O₃, AlO(OH) or mixed oxides or mixtures or core shell structures thereof. As fluoride, for example, MgF₂ can be used as a pure component or in a core shell structure with one of the above-mentioned oxides.

The mean particle diameter of the inorganic component should preferably be selected in such a way that the transparency of the coating is not affected. In a preferred embodiment, the colloidal inorganic component has a mean particle diameter in the range of 2 nm to 150 nm, and even more preferably of 2 nm to 70 nm. The mean particle diameter is measured through dynamic light scattering.

Preferably the colloidal inorganic component is present in an amount of 1% weight to 40% weight, and even more preferably of 5% weight to 25% weight, based on the total weight of the composition.

As already mentioned above, the composition in accordance with the invention contains as component (d) a cycloaliphatic or aromatic epoxide compound that has at least two epoxide groups.

This can for example also be a prepolymer with 2 or more epoxy functionalities.

Within the scope of this invention it is therefore essential that the epoxide compound of component (d) has a cyclic group, either in the form of a cycloaliphatic or an aromatic unit.

As discussed further below, the use of a cycloaliphatic or aromatic epoxide compound in comparison to a non-cyclic epoxide compound leads to an improved compromise between scratch resistance, resistance to bases and bonding strength on the substrate.

Preferably the cycloaliphatic compound is a substituted cyclohexane or substituted cyclopentane that has at least two substituents with at least one epoxide group each, or a mixture of these epoxide compounds, or a prepolymer of this compound.

Preferably the aromatic compound is a substituted benzene, substituted diphenylmethane derivative or substituted bisphenol that has at least two substituents with at least one epoxide group each, or a mixture of these epoxide compounds, or a prepolymer of this compound.

Preferably the cycloaliphatic or aromatic epoxide compound has at least two substituents that can be the same or different and that are represented by the following formula:

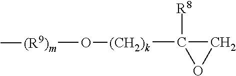

wherein

R⁸ has the meaning already indicated above (i.e. hydrogen or C₁₋₄-alkyl) and

R⁹ the meaning already indicated above (i.e. C₁₋₁₀-alkylene, preferably C₁₋₄-alkylene),

k is 1-4, preferably 1-2,

and m is 0 or 1.

Resorcinol bisglycidyl ether and cyclohexandimethanol bisglycidyl ether or their mixtures can e.g. be mentioned as preferred cycloaliphatic or aromatic epoxide compounds that have at least two epoxide groups.

Preferably the cycloaliphatic or aromatic compound that has at least two epoxide groups is present in an amount of 0.1% weight to 20% weight, preferably of 0.5% weight to 10% weight, based on the total weight of the composition.

As already mentioned above, the composition in accordance with the invention comprises as component (e) a solvent that contains an alcohol, ether and/or ester.

If the solvent contains an alcohol, this is preferably selected from an alkanol, cycloalkanol, aryl alcohol, alkylene glycol, monoalkyl ether of polyoxyalkylene glycols or monoalkyl ether of alkylene glycols or their mixtures.

Preferably, the alcohol is selected from a C₁₋₆-alkanol, more preferably a C₁₋₄-alkanol, a mono-C₁₋₄-alkyl ether of a C₂₋₄-alkylene glycol, or a mixture thereof.

If the solvent contains an ether, this is preferably selected from a dialkyl ether, a cycloaliphatic ether, an aryl ether or alkyl aryl ether or their mixtures.

If the solvent contains an ester, this is preferably selected from an alkyl ester, cycloalkyl ester, aryl alkyl ester, alkylene glycol ester or their mixtures.

With regard to the homogeneity and optical quality of the coating manufactured from the composition, it can be advantageous if the solvent contains two alcohols, ethers or esters with different boiling points.

Preferably the solvent contains a first alcohol, ether or ester with a boiling point S1 and a second alcohol, ether or ester with a boiling point S2, whereby the boiling point S1 and the boiling point S2 vary in such a way that either

S1/S2≧1.2

or

S1/S2≦0.8

Preferably the solvent contains a C₁₋₄-alkanol as the first alcohol and a monoalkyl ether of an alkylene glycol, preferably a mono-C₁₋₄-alkyl ether of a C₂₋₄-alkylene glycol as the second alcohol.

Preferably the weight ratio of the first alcohol to the second alcohol is in the range of 5 to 0.01, and preferably in the range of 2 to 0.2.

Preferably the composition also contains water. In a preferred embodiment, the water is present in an amount of 2 to 15% weight, based on the total weight of the composition.

Preferably, the composition in accordance with the invention also contains a catalyst for epoxide polymerization.

Within the scope of this invention, both a catalyst for the photo polymerization and a catalyst for the thermal polymerization of epoxides can be used. Both catalyst groups are in principle well known to the expert.

In a preferred embodiment, the composition contains a catalyst for the thermal polymerization of epoxides but no catalyst for the photo polymerization of epoxides.

As a catalyst for the thermal polymerization of epoxides, the compounds known to the expert for this purpose can be used.

Preferably the catalyst comprises a Lewis acid.

For example, the following can be mentioned as suitable catalysts for the thermal polymerization of epoxides:

metal acetylacetonates, diamides, imidazoles, amines and ammonium salts, organic sulphonic acids and their amine salts, alkali metal salts of carboxylic acids, alkali metal salts, fluoride salts and organotin compounds as well as metal alkoxides and mixtures thereof.

Preferably the catalyst is present in an amount in the range of 0.01% weight to 5% weight, and preferably in the range of 0.1% weight to 3% weight, based on the total weight of the composition.

As other optional components of the composition, surfactants (e.g. to assist with film formation), UV-absorbers, dyes and/or stabilisers can be mentioned.

For the coating procedure it can be advantageous if the silanes of Formula (I) and/or (II) already have a certain cross-linkage at the time of their application to the substrate. A defined pre-condensation can e.g. be achieved through hydrolysis of the silanes of Formula I and/or II catalysed with water or an aqueous organic or mineral acid.

The composition can be applied to the substrate through methods known to the expert.

For example, dip coating, spin coating, spray coating, flooding and slit nozzle application can be mentioned in this context.

With dip coating, the composition in accordance with the invention can also be applied to surfaces of substrates with more complex geometry.

Within the scope of this invention, a large number of different substrates can be used. Plastic substrates or even glass substrates can e.g. be coated with the composition in accordance with the invention.

A suitable plastic substrate can e.g. have one or more of the following plastics:

polycarbonate, poly(methyl)methacrylate, polyurethane, polyamide, polydiethylene glycol-bis-allyl carbonate (CR39), polythiourethane such as e.g. MR-6, MR-7, MR-8, MR-10, MR-174.

In the case of the substrate to be coated, these are preferably those used in optical applications.

Preferably for the substrate this is a lens for application as plastic eyeglass glass or a magnifying glass.

Preferably the substrate is thermally treated at a temperature in the range of 75° C. to 150° C., and even more preferably in the range of 90° C. to 130° C.

### EXAMPLES

### Chemicals

### IPA-ST: SiO₂-Nano-Sol by Nissan Chemicals, Houston

FC4430: Flow agent of the firm 3M
Other chemicals and solvents: Aldrich

### Test Methods

### Test of Resistance to Bases:

Coated glasses (−2.0 dioptres) were treated in an alkaline solvent (pH>14) at 50° C. with ultrasound for 180 seconds. Layer thicknesses before and after the treatment were measured optically in the same spot. The thickness of the hard layers was typically 2.5 μm. The base resistance is then measured using layer degradation, whereby the less the layer degradation, the better the base resistance.

The Bayer test to evaluate the scratch resistance was measured with a COLTS Bayer-test device and the appropriate method.

Layer bonding was evaluated via a lattice cutting test.

### Example 1

36 parts of resorcinol bisglycidyl ether were dissolved in 162 parts of 2-propanol and 264 parts of 1-methoxy-2-propanol. 186 parts of 3-glycidoxypropyl trimethoxysilane, 150 parts of tetraethoxysilane, 240 parts of IPA-ST and 126 parts of water were added to the solution and agitated at room temperature for 24 hours. After that 7.2 parts of aluminium acetylacetonate, 25.2 parts of ammonium perchlorate 1M solution, and 3.6 parts of FC4430 were added and the mixture was agitated for a further 3 hours. The resultant solution was filtered through a 5 μm filter and stored in the refrigerator before the coating.

### Example 2

36 parts of 1,4-cyclohexandimethanol diglycidyl ether were dissolved in 162 parts of 2-propanol and 264 parts of 1-methoxy-2-propanol. 186 parts of 3-glycidoxypropyl trimethoxysilane, 150 parts of tetraethoxysilane, 240 parts of IPA-ST and 126 parts of water were added and agitated at room temperature for 24 hours. After that 7.2 parts of aluminium acetylacetonate, 25.2 parts of ammonium perchlorate 1M solution, and 3.6 parts of FC4430 were added and the mixture was agitated for a further 3 hours. The resultant solution was filtered through a 5 μm filter and stored in the refrigerator before the coating.

### COMPARATIVE EXAMPLE 1

36 parts of trimethylolpropane triglycidyl ether were dissolved in 162 parts of 2-propanol and 264 parts of 1-methoxy-2-propanol. 186 parts of 3-glycidoxypropyl trimethoxysilane, 150 parts of tetraethoxysilane, 240 parts of IPA-ST and 126 parts of water were added and agitated at room temperature for 24 hours. After that 7.2 parts of aluminium acetylacetonate, 25.2 parts of 1M ammonium perchlorate solution, and 3.6 parts of FC4430 were added and the mixture was agitated for a further 3 hours. The resultant solution was filtered through a 5 μm filter and stored in the refrigerator before the coating.

### COMPARATIVE EXAMPLE 2

36 parts of pentaerythritol tetraglycidyl ether were dissolved in 162 parts of 2-propanol and 264 parts of 1-methoxy-2-propanol. 186 parts of 3-glycidoxypropyl trimethoxysilane, 150 parts of tetraethoxysilane, 240 parts of IPA-ST and 126 parts of water were added to the solution and agitated at room temperature for 24 hours. After that 7.2 parts of aluminium acetylacetonate, 25.2 parts of 1M ammonium perchlorate solution, and 3.6 parts of FC4430 were added and the mixture was agitated for a further 3 hours. The resultant solution was filtered through a 5 μm filter and stored in the refrigerator before the coating.

### COMPARATIVE EXAMPLE 3

186 parts of 3-glycidoxypropyl trimethoxysilane, 186 parts of tetraethoxysilane, and 240 parts of IPA-ST were mixed in 162 parts of 2-propanol, 264 parts of 1-methoxy-2-propanol and 126 parts of water and agitated at room temperature for 24 hours. After that 7.2 parts of aluminium acetylacetonate, 25.2 parts of 1M ammonium perchlorate solution and 3,6 parts of FC4430 were added and the mixture was agitated for a further 3 hours. The resultant solution was filtered through a 5 μm-filter and stored in the refrigerator before the coating.

The test substrates were activated before the dip coating with an aqueous-alkaline washing process and after the coating cured in an oven at 95° C. for 4 hours.

The coatings obtained with these compositions were tested for their base resistance (determined via the extent of layer degradation) and their scratch resistance (Bayer-Test). The results obtained are set out in Table 1.

TABLE 1
Layer test results

| | | Layer | |
|---|---|---|---|
| | Epoxide compound with at least two | breakdown | Bayer |
| Lacquer | epoxide groups | [μm] | value |
| Example 1 | Resorcinol diglycidyl ether | 0.2 | 6.1 |
| Example 2 | 1.4-cyclohexandimethanol diglycidyl | 0.8 | 5.2 |
| | ether | | |
| Compara- | trimethylolpropane triglycidyl ether | 0.6 | 4.7 |
| tive | | | |
| example 1 | | | |
| Compara- | pentaerythritol tetraglycidyl ether | cloudy | cloudy |
| tive | | | |
| example 2 | | | |
| Compara- | not present | complete | 6.2 |
| tive | | degradation | |
| example 3 | | | |

The results show that a coating with a high resistance to bases and very good scratch resistance is obtained with the compositions in accordance with the invention.

With the aid of the following examples, the crack formation and bonding of the coatings in accordance with the invention was tested on various substrates.

### Example 3

36 parts of resorcinol bisglycidyl ether were dissolved in 160 parts of 2-propanol and 265 parts of 1-methoxy-2-propanol. 240 parts of 3-glycidoxypropyl trimethoxysilane, 122 parts of tetraethoxysilane, 216 parts of IPA-ST and 126 parts of water were added to the solution and agitated at room temperature for 24 hours. After that 6 parts of aluminium acetylacetonate, 25.2 parts of 1M ammonium perchlorate solution and 3.6 parts of FC4430 were added and the mixture was agitated for a further 3 hours. The resultant solution was filtered through a 5 μm filter and stored in the refrigerator before the coating.

### Example 4

69 parts of resorcinol bisglycidyl ether were dissolved in 160 parts of 2-propanol and 265 parts of 1-methoxy-2-propanol. 227 parts of 3-glycidoxypropyl trimethoxysilane, 102 parts of tetraethoxysilane, 216 parts of IPA-ST and 126 parts of water were added to the solution and agitated at room temperature for 24 hours. After that 6 parts of aluminium acetylacetonate, 25.2 parts of 1M ammonium perchlorate solution and 3.6 parts of FC4430 were added and the mixture was agitated for a further 3 hours. The resultant solution was filtered through a 5 μm filter and stored in the refrigerator before the coating.

The coatings obtained from these compositions were tested for their primary bonding and their resistance to cracking. The results obtained are shown in Table 2.

TABLE 2
Bonding and crack formation properties

| | | | | | | Layer |
|---|---|---|---|---|---|---|
| | | | | | Crack | degra- |
| | Multi- | Primary bonding | | | forma- | dation |
| Lacquer | epoxy | CR39 | MR7 | MR8 | tion | [μm] |
| Example | 3% | no | no | no | no | 0.0 |
| 3 | resorcinol | peeling | peeling | peeling | cracks | |
| | diglycidyl | | | | | |
| | ether | | | | | |
| Example | 6% | no | no | no | no | 0.0 |
| 4 | Resorcinol- | peeling | peeling | peeling | cracks | |
| | diglycidyl | | | | | |
| | ether | | | | | |

These examples demonstrate that, with the compositions in accordance with the invention, coatings are obtained that show a very good substrate bonding and at the same time have very good base resistance (no layer degradation) and resistance to cracking.

The invention claimed is:

1. A composition for the manufacture of a coating, comprising:
(a) One or more of the following:
1) a silane derivative of Formula (I) 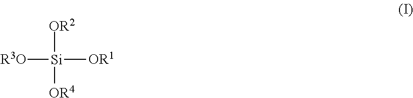
whereby
R¹, R², R³ and R⁴ that can be the same or different are selected from alkyl, acyl, alkylene acyl, cycloalkyl, aryl or alkylene aryl that can be substituted where necessary;
2) at least one hydrolysis product of the silane derivative of Formula (I); and
3) at least one condensation product of the silane derivative of Formula (I);
(b) One or more of the following:
1) a silane derivative of Formula (II)
R⁶R⁷₃₋ₙSi(OR⁵)ₙ (II)
wherein
R⁵ is an unsubstituted or substituted alkyl, acyl, alkylene acyl, cycloalkyl, aryl or alkylene aryl group,
R⁶ is an organic residue that contains an epoxide group,
R⁷ is an unsubstituted or substituted alkyl, cycloalkyl, aryl or alkylene aryl group,
n is 2 or 3,
2) at least one hydrolysis product of the silane derivative of Formula (II); and
3) at least one condensation product of the silane derivative of Formula (II);
(c) at least one of the following: a colloidal inorganic oxide, a colloidal inorganic fluoride; and a colloidal inorganic oxyfluoride;
(d) at least one or the following: a cycloaliphatic or aromatic epoxide compound that has at least two epoxide groups; and
(e) a solvent that contains an alcohol, ether and/or ester.

2. The composition according to claim 1, wherein at least one of: the silane derivative of Formula (I); the hydrolysis product(s) of the silane derivative of Formula (I); and the condensation product(s) of the silane derivative of Formula (I) is or are present in the composition in an amount of 1% by weight to 35% by weight of the composition.

3. The composition according to claim 1, wherein the residue R⁶ in the silane derivative of Formula (II) has the following Formula (III): 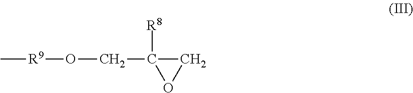
wherein
R⁸ is hydrogen or C₁₋₄-alkyl; and
R⁹ is C₁₋₁₀-alkylene.

4. The composition according to claim 2, whereby the residue R⁶ in the silane derivative of Formula (II) has the following Formula (III): 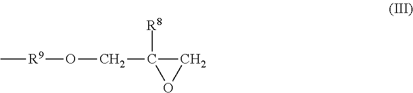
wherein
R⁸ is hydrogen or C₁₋₄-alkyl; and
R⁹ is C₁₋₁₀-alkylene.

5. The composition according to claim 1, wherein the silane derivatives of Formula (II); the hydrolysis product(s) of the silane derivative of Formula (II); and the condensation product(s) of the silane derivative of Formula (II) is or are present in the composition in an amount of 1% weight to 35% weight.

6. The composition according to claim 2, wherein the silane derivatives of Formula (II); the hydrolysis product(s) of the silane derivative of Formula (II); and the condensation product(s) of the silane derivative of Formula (II) is or are present in the composition in an amount of 1% weight to 35% weight.

7. The composition according to claim 1, wherein the weight ratio of X to Y is in the range of 95/5 to 5/95; wherein X is the silane derivative of Formula (I); the hydrolysis product(s) of the silane derivative of Formula (I); and the condensation product(s) of the silane derivative of Formula (I) and Y is the silane derivatives of Formula (II); the hydrolysis product(s) of the silane derivative of Formula (II); and the condensation product(s) of the silane derivative of Formula (II).

8. The composition according to claim 2, wherein the weight ratio of X to Y is in the range of 95/5 to 5/95; wherein X is the silane derivative of Formula (I); the hydrolysis product(s) of the silane derivative of Formula (I); and the condensation product(s) of the silane derivative of Formula (I) and Y is the silane derivatives of Formula (II); the hydrolysis product(s) of the silane derivative of Formula (II); and the condensation product(s) of the silane derivative of Formula (II).

9. The composition according to claim 5, wherein the weight ratio of X to Y is in the range of 95/5 to 5/95; wherein X is the silane derivative of Formula (I); the hydrolysis product(s) of the silane derivative of Formula (I); and the condensation product(s) of the silane derivative of Formula (I) and Y is the silane derivatives of Formula (II); the hydrolysis product(s) of the silane derivative of Formula (II); and the condensation product(s) of the silane derivative of Formula (II).

10. The composition according to claim 6, wherein the weight ratio of X to Y is in the range of 95/5 to 5/95; wherein X is the silane derivative of Formula (I); the hydrolysis product(s) of the silane derivative of Formula (I); and the condensation product(s) of the silane derivative of Formula (I) and Y is the silane derivatives of Formula (II); the hydrolysis product(s) of the silane derivative of Formula (II); and the condensation product(s) of the silane derivative of Formula (II).

11. The composition according claim 1, wherein the colloidal inorganic oxide is selected from the group comprising SiO₂, TiO₂, ZrO₂, SnO₂, Sb₂O₃, Al₂O₃, AlO(OH), mixed oxides, mixtures thereof, and core shell structures thereof; and the colloidal inorganic fluoride is MgF₂ that is optionally present in the core shell structure with the inorganic oxide.

12. The composition according to claim 11, wherein the total of the colloidal inorganic oxide, the colloidal inorganic oxide fluoride and the colloidal inorganic oxide oxyfluoride is in an amount of 1% weight to 25% weight based on the total weight of the composition.

13. The composition according to claim 11, wherein the total of the colloidal inorganic oxide, the colloidal inorganic oxide fluoride and the colloidal inorganic oxide oxyfluoride is in an amount of 1% weight to 25% weight based on the total weight of the composition.

14. The composition according to claim 13, wherein the cycloaliphatic or aromatic epoxide compound has at least two substituents that can be the same or different and that are represented by the following formula: 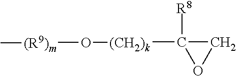
wherein
R⁸ is hydrogen or C₁₋₄-alkyl,
R⁹ is an unsubstituted or substituted C₁₋₁₀-alkylene group, preferably an unsubstituted or substituted C₁₋₄-alkylene group;
k is 1-4; and
m is 0 or 1.

15. The composition according to claim 1, wherein the cycloaliphatic or aromatic epoxide compound has at least two substituents that can be the same or different and that are represented by the following formula: 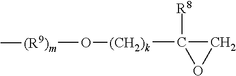
wherein
R⁸ is hydrogen or C₁₋₄-alkyl,
R⁹ is an unsubstituted or substituted C₁₋₁₀-alkylene group, preferably an unsubstituted or substituted C₁₋₄-alkylene group;
k is 1-4; and
m is 0 or 1.

16. The composition according to claim 15, wherein the cycloaliphatic or aromatic compound that has at least two epoxide groups is present in an amount of 0.1% weight to 20% weight based on the total weight of the composition.

17. The composition according to claim 1, wherein the solvent contains is chosen from the group consisting of an alcohol that is selected from a C₁₋₆-alkanol, preferably a C₁₋₄-alkanol, a mono-C₁₋₄-alkyl ether of a C₂₋₄-alkylene glycol, a mixture of the preceding alcohols; a dialkyl ether, a cycloaliphatic ether, an aryl ether, an alkyl aryl ether, an alkyl ester, a cycloalkyl ester, an aryl alkyl ester and an alkylene glycol ester.

18. The composition according to claim 1, wherein the solvent contains a first alcohol, ether or ester with a boiling point Si and a second alcohol, ether or ester with a boiling point S2, whereby the boiling point S1 and the boiling point S2 vary such that either
S1/S2≧1.2
or
S1/S2≦0.8.

19. The composition according to claim 1 further comprising a catalyst for the thermal polymerization of epoxides.

20. A method for coating a substrate comprising the following steps:
providing a composition according to claim 1;
applying the composition to the substrate; and
forming a cured coating by heating the composition applied to the substrate at a temperature in the range of 75° C. to 150° C. to cure the coating.

21. An article comprising:
a substrate; and
a cured coating on the surface of the substrate, wherein a composition according to claim 1 which has been heated on the substrate surface at a temperature in the range of 75° C. to 150° C. forms the cured coating on the substrate surface.
